(19) United States
(12) Patent Application Publication
(10) Pub. No.: US 2020/0131407 A1
(43) Pub. Date: Apr. 30, 2020

(54) METHOD OF MAKING ADHESIVE CABLE-WRAP TAPE

(71) Applicant: CERTOPLAST TECHNISCHE KLEBEBÄNDER GMBH, Wuppertal (DE)

(72) Inventor: Thorsten MEIER, Essen (DE)

(21) Appl. No.: 16/618,927

(22) PCT Filed: Jun. 26, 2018
(86) PCT No.: PCT/EP2018/067149

§ 371 Date: Dec. 13, 2019

(30) Foreign Application Priority Data
Jun. 27, 2017 (DE) 102017114266.5

(51) Int. Cl. C09J 7/38; C09J 133/04

(52) U.S. Cl. CPC C09J 7/385; C09J 133/04; C09J 2400/263; C09J 2205/31; C09J 2203/302

(57) ABSTRACT

The invention relates to a method for producing an adhesive tape, in particular a wrapping tape for wrapping around cables in automobiles. A strip-shaped carrier (2) is provided with a UV cross-linkable adhesive coating (5). In addition to an acrylate-based pressure-sensitive adhesive with embedded photoinitiators, the adhesive coating (5) comprises at least one additive. The photoinitiators are activated for cross-linking by irradiation with a UV light source (6) emitting in the range of its activation wavelength. According to the invention, the activation wavelength of the photoinitiators is above 280 nm, in particular above 315 nm.

The invention relates to a method of making adhesive tape, in particular a tape for wrapping cables in automobiles, according to which a substrate strip is provided with a UV-cross-linkable adhesive coating that comprises, in addition to an acrylate-based pressure-sensitive adhesive with embedded photoinitiators, at least one additive, and according to which the photoinitiators are activated for cross-linking through irradiation with a UV light source radiating in the range of their activation length. The photoinitiators that are incorporated into the adhesive coating can be copolymerized, mixed, or otherwise introduced into the adhesive coating.

The above-described method is described for example in EP 1 548 080. It relates overall to a technical adhesive tape suitable for use in construction. For this purpose, a high specific weight per unit area of at least 100 g/m² is used for the adhesive coating. Especially effective adhesion is thus attained even on rough surfaces by these parameters.

In addition to the acrylate-based pressure-sensitive adhesive with incorporated photoinitiators, UV-cross-linkable adhesive coatings typically also have an additive that is generally intended to increase adhesion to the substrate strip. This is especially true for nonpolar substrate surfaces. However, such additives may interfere with subsequent cross-linking. In fact, the substrate strip is typically first provided with the adhesive coating and then irradiated with the UV light source.

The UV light source primarily ensures that the photoinitiators are irradiated with the required UV dose in the range of their activation wavelength so that the desired cross-linking of the adhesive coating takes place. An emission maximum of the UV light source need not necessarily coincide with the activation wavelength of the photoinitiators. Rather, what is crucial is that the UV light source make the required UV dose available in the range of the activation wavelength of the photoinitiators, and optionally for longer treatment times as well. In fact, the photoinitiators incorporated in the acrylate-based pressure-sensitive adhesive ensure that the acrylate polymers are combined to form a relatively wide-meshed network.

In order not to jeopardize the cross-linking and consequently the activation of the photoinitiators, it is emphasized in the prior art in the context of a publication by BASF on the topic of “UV-Curable acrylic hot-melts for PSA's” with a publication date of 22 May 2001 that, for this reason, the additive to the pressure-sensitive adhesive must have no absorption or practically no absorption in the range of the relevant activation wavelength of the photoinitiators. It is purported that sufficient UV-C light is otherwise unable to penetrate into the adhesive coating in the exemplary case in order to ensure the above-described cross-linking over the entire surface.

In this context, as is generally customary, UV-C light corresponds to a wavelength range between 200 and 280 nm, which is also referred to as far UV and is to be understood as such below. In contrast, middle UV or UV-B radiation characterizes the wavelength range from 280 nm to 315 nm. Near UV or black light, as UV-A radiation, corresponds to the wavelength range from 315 nm to 380 nm. Either way, and as a consequence of the ranges described above, only those additives besides the acrylate-based pressure-sensitive adhesive with the incorporated photoinitiators that have practically no absorbency in the range of the activation wavelength have been found to be usable.

One such commercially available product is marketed under the name Foral 85 or Foral 105. Both of these are abietic ester-based resin blends, as long they are hydrogenated and consequently have the required transmissibility in the range of the activation wavelength. One drawback of the above-described resin admixtures is their price, which can sometimes even exceed that of the actual acrylate-based pressure-sensitive adhesive with the incorporated photoinitiators.

A pressure-sensitive adhesive coating is described in WO 2016/186877 [US 2018/0327640] that is also used for the manufacture of adhesive tapes with a fabric support, for example. The adhesive coating uses an acrylate with incorporated photoinitiators that are cross-linked by UV lamps. Moreover, the previously mentioned product Foral 85 is cited as a suitable additive at the top of page 16.

The object of the invention is to further develop such a method of making an adhesive tape and, in particular, wrapping tape such that the manufacturing costs are substantially reduced.

A method of making a wrapping tape is provided according to claim 1 in order to attain this object.

In the context of the invention, photoinitiators are thus deliberately selected whose activation wavelength differs markedly from that which is typically used in commercially available products such as the acResin pressure-sensitive adhesive from BASF, which absorb primarily in the range from 250 to 260 nm. In fact, photoinitiators have been used in the prior art that absorb predominantly in the UV-C range and consequently require a UV light source that emits at least, also, in the UV-C range in question in order to be activated. This requirement and design has come to be accepted essentially due to the insight and practical experience that this is the only way to avoid practically uncontrolled cross-linking as a result of sunlight, for example. In fact, natural sunlight has a spectral distribution that typically begins only at the short-wave end of the UV-A range. Consequently, uncontrolled cross-linking caused by sunlight can be practically ruled out in the UV-C range.

It is for this reason that mercury vapor lamps such as those known from the prior art according to EP 1 548 080, for example, have been heretofore used for cross-linking. Such mercury vapor lamps have significant emission peaks in the UV-C range and are therefore suitable for cross-linking the photoinitiators that have been used up to now. However, such mercury vapor lamps often require additional cooling, are thus complicated to manage, and are only available at a relatively high price.

In contrast, the invention deliberately works with photoinitiators whose activation wavelength is above 280 nm. As a basic principle and for the sake of example, such photoinitiators are described in DE 695 15 310 [U.S. Pat. No. 5,773,485]. In particular, photoinitiators are even used that are activated above 315 nm. That is, the UV light source used here can be one that emits primarily in the UV-A range, i.e. in the wavelength range between 315 nm and 380 nm.

Such UV-A light sources are available at low cost and in large quantities.

This is especially true if an LED-based light source is used as the UV light source. After all, based the previously described design, the LED-based UV light source can be a UV-A LED light source. Such UV-A LED light sources are available in large quantities and at low cost, so that the manufacturing costs can be significantly reduced compared to previous approaches. The effort involved is also reduced, because UV light sources typically do not require additional cooling.

The UV light source generally irradiates the adhesive coating with a UV dose of at least 15 mJ/cm², preferably at least 30 mJ/cm². In particular, a UV dose of at least 50 mJ/cm² is observed. As a rule, a UV dose of from 150 mJ/cm² to 500 mJ/cm² is used. Preferably, UV doses in the range between 200 mJ/cm² to 400 mJ/cm² are observed. In a wavelength range of about 250 nm to 260 nm, a dose of 60 to 80 mJ/cm² has proven to be especially favorable. Such UV doses can be used in an especially simple manner and without any difficulty with LED-based UV light sources, because UV-LED light sources have a broad emission spectrum and, unlike mercury lamps, exhibit no pronounced emission peaks. This means that the UV LED light source can be expected to have a uniform emission spectrum.

According to another advantageous embodiment that is of particular importance, the substrate strip receiving the adhesive coating is also designed to be opaque so that, in particular, it absorbs incident daylight radiation. By virtue of this design, uncontrolled cross-linking as a result of sunlight also cannot be expected according to the invention. After all, the substrate strip provided with the adhesive coating is initially rolled up into individual rolls after UV cross-linking.

These rolls are characterized in that the adhesive coating is arranged on the inside of the spiral produced in this manner, whereas the opaque substrate strip faces outward. As a result, any daylight radiation is practically unable to penetrate into the adhesive coating. And if it does, all that occurs, if anything, is an additional and slight cross-linking of the acrylate-based pressure-sensitive adhesive with the incorporated photoinitiators, which is or can be inherently desirable.

With regard to a use for the adhesive tape, it is typically used for wrapping cables in automobiles. Consequently, the adhesive tape or wrapping tape in question is generally wrapped helically around the cables of a cable set to be sheathed or gathered. During this helical wrapping of the cables of the cable set, each of the opaque substrate strips faces outward again, so that, in turn, the adhesive coating that is provided on the inside is practically not reached by the daylight, or in a controlled manner at most. The desired degree of cross-linking of the acrylate-based pressure-sensitive adhesive with the incorporated photoinitiators, and hence the adhesive force to a large extent, can thus be set with the aid of the UV light source during the manufacturing process without the likelihood of changes occurring to this setting as a result of subsequent processing.

The photoinitiators are usually introduced into the adhesive coating at a grammage of at least 0.05 wt %. In general, a grammage of from 0.2 wt % to 5 wt % is used. The photoinitiators are generally incorporated into the network of acrylic-based pressure-sensitive adhesive, that is, they are the incorporated photoinitiators. As usual, the cross-link density and hence the adhesive characteristics of the adhesive coating can be adjusted within certain limits by controlling the size of the UV dose. Thus, a high UV dose tends to increase the shear strength of the adhesive coating, while at a lower UV dose, higher tack with lower shear strength can to be expected. In any case, these production engineering parameters that are set, and thus the cross-linking density, is not or practically not affected by the subsequent processing of the adhesive tape as tape for wrapping cables in automobiles. After all, any sunlight is soundly and almost completely absorbed by the opaque substrate strip that faces outward in the processed state.

The adhesive coating is generally applied to the support with an application weight of greater than 15 g/cm², in particular of greater than g/cm², and preferably with an application weight of greater than 50 g/cm². As an upper limit, the invention recommends a coating weight of 200 g/cm², preferably an upper limit of 90 g/cm². The additive is typically a resin admixture for increasing adhesion to the substrate strip. The substrate strip as such is usually a textile fabric. This can be a nonwoven or woven fabric, or even a fluorine. The weight per unit area of the textile fabric is between 50 g/m² and 250 g/m². Preferably, weights per unit area of between 70 g/m² and 200 g/m² are observed.

In order to impart the above-described opaque quality to the substrate strip, the textile fabric is usually dyed. Dyeing with black color has proven expedient, for example. In principle, it is sufficient in any case that the outwardly facing textile substrate strip be opaque enough in the processed state that any incident sunlight does not or practically does not or cannot penetrate it as far as the adhesive coating.

As a result, a method of making an adhesive tape is described that involves substantially reduced production costs compared to previous approaches in the prior art. This can basically be attributed to two aspects. First of all, the use of photoinitiators with an activation wavelength above 280 nm makes it possible to utilize UV-A light sources, which are particularly inexpensive and easy to manage. This is particularly true in a case in which UV-A LED light sources are used for cross-linking the adhesive coating.

On the other hand, and as an additional essential effect, it should be noted that the adhesive coating according to the invention is or can be provided with an additive to the pressure-sensitive adhesive, which is also available at low cost. The additive is present in the adhesive coating in a grammage of at least 5 wt % or at least 10 wt %. In addition, an upper limit of from 30 wt % to 40 wt % is usually observed for the additive. After all, the purpose of this additive is practically only that it, as a resin admixture, for example, enhances adhesion of the adhesive coating to the substrate strip. Other, farther-reaching requirements do not exist or are practically nonexistent. In particular, the resin admixtures based on hydrogenated abietic acid esters that are regarded as being virtually indispensable in the prior art are in fact expressly dispensable because, according to the invention, the transparency imparted by these additives in the wavelength range between 250 nm and 260 nm does not matter at all.

Rather, it is sufficient if the resin in question that is added to the acrylate-based pressure-sensitive adhesive with the incorporated photoinitiators be not absorbed or hardly absorbed near the activation wavelength of the photoinitiators, that is, above 280 nm and particularly above 315 nm. According to the invention, this is to be understood to mean that the absorption or absorbency E of the relevant resin admixture in the range of the activation wavelength of the photoinitiators, i.e. above 280 nm and particularly above 315 nm, is typically reduced by a factor of 5, in particular by a factor of 10. The reduction in question arises relative to the range below the activation wavelength, in the present case below 280 nm and particularly below 315 nm. This criterion is met by almost all commercially available resin admixtures or tackifiers, so that the cost of the adhesive tape made by the method according to the invention can be significantly reduced compared to the prior art. Herein lie the fundamental advantages.

The invention is described in further detail below with reference to a schematic drawing showing only one embodiment:

FIG. 1 is a schematic view of an apparatus for carrying out the method according to the invention,

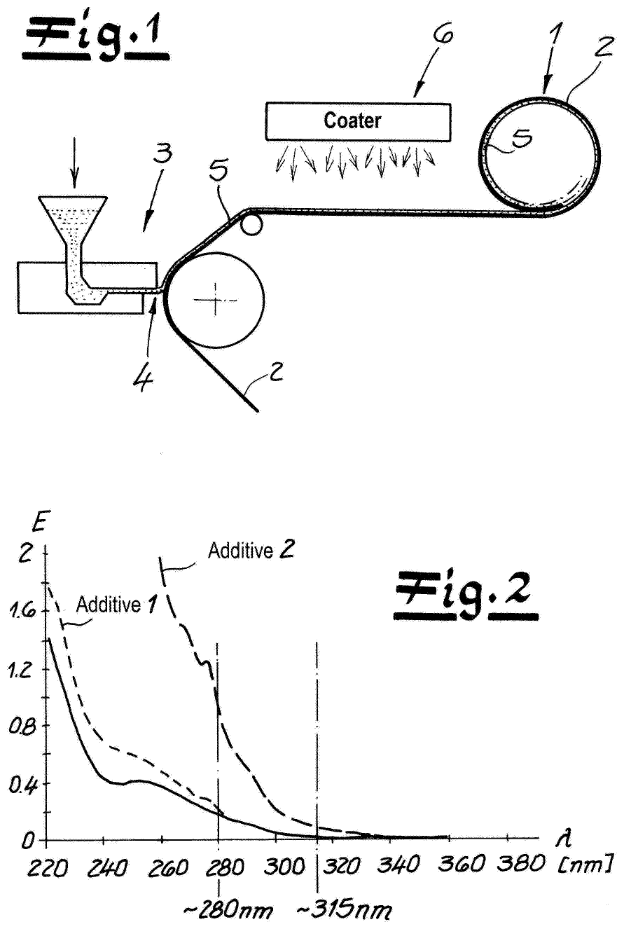

FIG. 2 is a graph of an absorption spectrum of the acrylate-based pressure-sensitive adhesive with incorporated photoinitiators and two variants with different additives, and

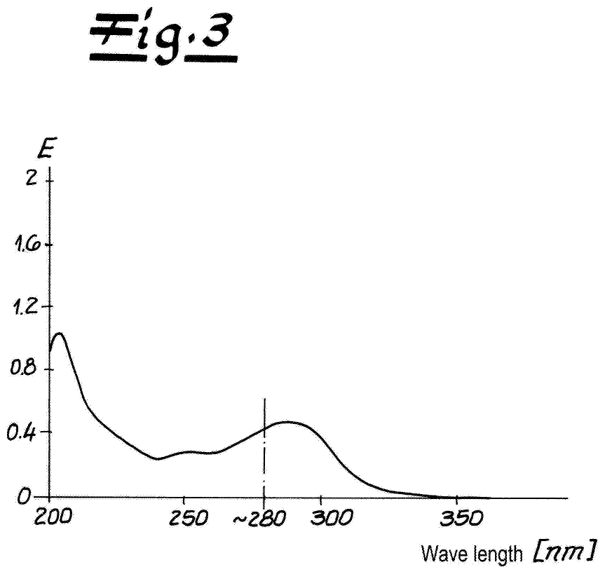

FIG. 3 is a graph of the absorption spectrum of the photoinitiators used according to the invention.

FIG. 1 shows an apparatus for making an adhesive tape 1. For this purpose, a substrate strip 2 is fed to a coater 3 for hot-melt adhesive. In the coater 3 for the hot-melt adhesive, the hot-melt adhesive is at a temperature of about 100° C. to 150° C. and can be applied to the substrate strip 2 being moved past the nozzle 4 via an output-side nozzle 4 of the coater 3, thereby coating the substrate strip 2.

The substrate strip 2 is a substrate strip 2 formed of a textile fabric and has a weight per unit area of between 50 g/m² and 250 g/m². After coating of the substrate strip 2 with an adhesive coating 5 in this manner, the adhesive coating 5 is cross-linked by a UV light source 6 that is above the continuously coated substrate strip 2. As will readily be understood, the adhesive coating 5 faces the UV light source 6 during this process. The light source 6 is an LED-based light source. In fact, a large number of LED's are used here. In principle, however, the UV light source 6 can also for example use a mercury vapor lamp. That is not shown, however.

The substrate strip 2 that has been provided with the adhesive coating 5 moves beneath the UV light source 6 at a speed of from 10 m/min to 100 m/min or more. The adhesive coating 5 is irradiated by the UV light source 6 at a UV dose of at least 15 mJ/cm². According to the embodiment, a UV dose in the range of from 150 mJ/cm² to 500 mJ/cm² is used. The UV light source 6 emits, inter alia, in the range of the activation wavelength for the photoinitiators incorporated in the adhesive coating 5, that is, primarily in a range above 280 nm.

The adhesive coating 5 has at least one additive in addition to an acrylate-based pressure-sensitive adhesive with incorporated photoinitiators. As an additive, the invention makes use of a resin admixture based on a merely partially hydrogenated abietic acid ester. After the substrate strip 2 has been provided with the adhesive coating 5, the adhesive tape 1 made in this manner can for example be wound up or cut in the longitudinal direction if a fabric web is being fed to the coater 3 here as the substrate strip 2. This is known in detail.

FIG. 2 shows the absorption or absorbency E relative to the wavelength. Dimensionless absorbency E is known to be a measure of the reduction in the intensity of the light measured in a photometer as it passes through the corresponding sample. The progression of the absorbency or absorption relative to the wavelength for the acrylate-based pressure-sensitive adhesive used in the invention in this case, namely acResin A203UV, is shown by a solid line. The other curves relate to the acrylate-based pressure-sensitive adhesive in question, on the one hand with an additive 1 (dashed line). Additive 1 is a resin admixture based on abietic acid ester that has been partially hydrogenated. The dot-dashed variant with additive 2 also relates to a resin admixture based on abietic acid ester having only slight or virtually no partial hydrogenation. The product YT311 from Yser was used as additive 1. Additive 2 is YT321, also from Yser.

It can be seen that the adhesive coating 5 produced in this manner increasingly absorbs in the direction of higher UV wavelengths as the hydrogenation of the abietic ester-based resin admixture decreases. Since, according to the invention, the activation wavelength of the photoinitiators is above 280 nm and particularly above 315 nm, such resin admixtures can be used nonetheless, because sufficient light of the UV light source 6 penetrates into the adhesive coating 5 despite these resin admixtures. This is indicated by FIG. 2, which shows the minimum of the activation wavelength of 280 nm as well as the preferred range above 315 nm.

Finally, FIG. 3 also shows the absorption spectrum of the photoinitiators used according to the invention. In fact, the absorbency E is reproduced over the wavelength in this case as well. It can be seen that the absorption maximum of the photoinitiators used is in the range between about 280 nm and 300 nm, so that the appropriately configured activation wavelength of the UV light source 6 can cross-link the photoinitiators properly.

Finally, it should also be noted that the substrate strip 2 is opaque. For this purpose, the substrate strip 2 is a dyed textile fabric, for example a black-dyed woven fabric, a black-dyed nonwoven, etc. Incident natural UV light or daylight is thus absorbed by the substrate strip 2 because it faces outward both in the stored state and in the processing state. In fact, it can be seen from the device shown in FIG. 1 that the adhesive tape 1 in question is wound up with the substrate strip 2 facing outward in the roll, so that, when stored, no UV radiation can penetrate to the adhesive coating 5 inside due to the opaque substrate strip 2. The same applies to a case in which the adhesive tape 1 made in this manner is used in the specified manner as a tape for wrapping cables in automobiles.

After all, the adhesive tape 1 in question is wrapped helically for this purpose around the respective cables that are to be grouped together. In this case as well, the substrate strip 2 faces outward and ensures with its opaque character that any daylight and consequently UV components present in daylight do not or practically do not reach the adhesive coating 5 present on the inside tape face. As a result, the degree of cross-linking set during manufacturing is not or is practically not influenced.

In particular, the illustration in FIG. 2 in combination with FIG. 3 makes it clear that, in the context of the invention, the wavelength of the photoinitiators used, more particularly the absorption spectrum thereof, is or can be adapted to the UV light source 6. In fact, the photoinitiators are those containing benzoin ethers such as benzoin methyl ethers and are available, inter alia, under the trade name “IRGACURE 651.” Reference should also be made in this regard to above-cited WO 2016/186877 that describes such photoinitiators. In any case, this enables resin admixtures that are favorable overall in terms of production engineering and have no or hardly any absorbency in the range of the activation wavelength of the photoinitiators to be considered as additives for the purpose of increasing the adhesion to the substrate strip. This can be seen from FIG. 2 and for example from additive 2 whose absorbency E has fallen to values of 1.0 in the range above 280 nm, the activation wavelength of the photoinitiators, whereas absorbencies of 2 and even more are observed below the activation wavelength.

This circumstance becomes all the more clear if an activation wavelength of 315 nm is assumed. Here, the absorbency E of the additive 2 is less than 0.1, whereas the absorbency in the range below that takes on values that are typically 10 times that or more. In other words, the resin admixture, additive 2 in the example, has no or hardly any absorbency in the range of the activation wavelengths of the photoinitiators and above, which means that the absorbency E is reduced by at least a factor of 5, typically by a factor of 10 or more compared to the absorbency E of the resin admixture (additive 2) below the activation wavelength.

1. A method of making a tape for wrapping cables in automobiles, the method comprising the step of:
providing an opaque substrate strip having a UV-cross-linkable adhesive coating comprised of:
an acrylate-based pressure-sensitive adhesive with embedded photoinitiators cross-linkable by UV light of wavelength in a predetermined activation range, and
at least one additive formed of a resin admixture for increasing adhesion to the substrate strip and having no or hardly any absorbency in the range of the activation wavelength of the photoinitiators,
activating the photoinitiators are activated for cross-linking through irradiation with a UV light source that emits in the predetermined activation range, and
helically wrapping the tape around the cables of a cable set to be sheathed with the substrate strip facing outward.

2. The method according to claim 1, wherein the UV light source irradiates the adhesive coating with a UV dose of at least 15 mJ/cm².

3. The method according to claim 1, wherein an LED-based UV light source is used.

4. The method according to claim 3, wherein the LED-BASED UV light source is a UVA LED light source.

5. The method according to claim 1, wherein the photoinitiators are in to the adhesive coating in a grammage of at least 0.05 wt %.

6. The method according claim 1, further comprising the step of:
applying the adhesive coating to the substrate strip at an application weight of greater than 15 g/cm².

7. (canceled)

8. The method according to claim 1, wherein the substrate strip is a textile fabric with a weight per unit area of between 50 g/m² and 250 g/m².

9. The method according to claim 8, wherein the textile fabric is dyed.
